(19) United States
(12) Patent Application Publication
(10) Pub. No.: US 2016/0142576 A1
(43) Pub. Date: May 19, 2016

(54) IMAGE FORMING APPARATUS, POWER SUPPLY CONTROL METHOD, AND POWER SUPPLY CONTROL PROGRAM

(71) Applicant: Konica Minolta Inc., Tokyo (JP)

(72) Inventor: Shotaro Yamaguchi, Hino-shi (JP)

(73) Assignee: Konica Minolta Inc., Tokyo (JP)

(21) Appl. No.: 14/941,176

(22) Filed: Nov. 13, 2015

(30) Foreign Application Priority Data
Nov. 14, 2014 (JP) 2014-232102

(51) Int. Cl. H04N 1/00; G06K 9/00

(52) U.S. Cl. CPC H04N 1/00896; G06K 9/00369; H04N 2201/0094

(57) ABSTRACT

An image forming apparatus includes: an image former, accommodated in a housing, that forms an image on a sheet; a human detector that detects a person; a light emitter that emits light; a power supply that supplies power to the image former in any of multiple power supply modes including a normal mode and a power saving mode; and a controller. The controller sets a first detection area positioned outside of the housing and a second detection area contained in the first detection area, controls the light emitter to emit the light when the human detector detects the person in the first detection area, and controls to start terminating the power saving mode when the human detector detects the person in the second detection area.

The entire disclosure of Japanese Patent Application No. 2014-232102 filed on Nov. 14, 2014 including description, claims, drawings, and abstract are incorporated herein by reference in its entirety.

### BACKGROUND OF THE INVENTION

1. Technical Field

The present invention relates to an image forming apparatus, a power supply method, and a power supply program.

2. Background Art

In recent years, image forming apparatuses having power saving functions (also called power conservation functions) have been widely used. In such an image forming apparatus, when the apparatus has not been used by users for a certain period of time, for example, the power supply mode is switched from a normal mode to a power saving mode and functions used during normal operation are limited, which enables reduction in power consumption.

On the other hand, the image forming apparatus operating in the power saving mode terminates the power saving mode and returns to the normal mode, which is triggered by user's operation on an operation panel, reception of a print job from a client terminal connected via a network, or the like. It may take time, however, to return to the normal mode from the power saving mode, which keeps the user waiting in front of the image forming apparatus when the user operates the operation panel to make the image forming apparatus to return from the power saving mode to the normal mode.

In this context, JP 2014-98894 A discloses a technology of detecting a user moving toward an image forming apparatus and starting termination of the power saving mode before the user arrives in front of the image forming apparatus, so that the user waiting time is shortened.

With the technology of JP 2014-98894 A, however, the user cannot know what behaviors of a user moving toward the image forming apparatus are triggers for terminating the power saving mode. Thus, the power saving mode may be uselessly terminated even for a person (non user of the image forming apparatus) who is merely passing in front of the image forming apparatus without intention of using the image forming apparatus. As a result, the image forming apparatus wastefully consumes power, which disadvantageously undermines the power consumption reducing effect of the power saving functions.

### SUMMARY

One or more embodiments of the present invention provide an image forming apparatus, a power supply control method, and a power supply control program that prevent useless termination of a power saving mode for a person who does not intend to use the image forming apparatus.

One or more embodiments of the present invention are listed below.

According to one or more embodiments of the present invention, an image forming apparatus includes: an image former, accommodated in a housing, that forms an image on a sheet; a human detector that detects a person; a light emitter that emits light; a power supply that supplies power to the image former in any of multiple power supply modes; and a controller. The multiple power supply modes include a normal mode in which power enabling image forming by the image former is supplied and a power saving mode in which less power is supplied than in the normal mode. The controller sets a first detection area positioned outside of the housing and a second detection area contained in the first detection area, controls the light emitter to emit the light when the human detector detects the person in the first detection area, and controls to start terminating the power saving mode when the human detector detects the person in the second detection area.

In the image forming apparatus according to one or more embodiments, the controller may control the light emitter to illuminate the second detection area with light when the human detector detects the person in a third detection area that is an area excluding the second detection area from the first detection area.

In the image forming apparatus according to one or more embodiments, the light emitter may emit light toward a floor surface in the second detection area.

In the image forming apparatus according to one or more embodiments, the human detector may have a sensor that locates a position of the person, and the controller may control the light emitter to change a position of light emission on the floor surface in the second detection area according to the position of the person.

In the image forming apparatus according to one or more embodiments, the controller may control the light emitter to draw a marker following movement of the person in the third detection area and indicating a direction to the housing from the person.

In the image forming apparatus according to one or more embodiments, when the human detector detects the person in the second detection area, the controller may control the power supply to start terminating the power saving mode and turn off a sensor of the human detector.

In the image forming apparatus according to one or more embodiments, when the human detector detects the person in the third detection area, the controller may determine whether the person has moved from outside of the first detection area to the third detection area or from the second detection area to the third detection area. Furthermore, when the controller determines that the person has moved from outside of the first detection area to the third detection area, the controller may control the light emitter to illuminate the second detection area with light, and when the controller determines that the person has moved from the second detection area to the third detection area, the controller may control the light emitter not to illuminate the second detection area.

In the image forming apparatus according to one or more embodiments, when the controller determines that the person has stayed in the third detection area longer than a predetermined time, the controller may control the light emitter to suspend illumination of the second detection area with light.

In the image forming apparatus according to one or more embodiments, when the controller determines that the person has moved from the third detection area to the second detection area and the human detector detects the person in the second detection area and another person in the third detection area at the same time, the controller may control the light emitter to suspend illumination of the second detection area with light and may control the power supply to start terminating the power saving mode.

In the image forming apparatus according to one or more embodiments, when the human detector detects the person in the second detection area and another person in the third detection area at the same time, the controller may control the power supply to start terminating the power saving mode.

In the image forming apparatus according to one or more embodiments, when the controller determines that the person has moved from the second detection area to the third detection area and another person has moved from outside of the first detection area to the third detection area, the control unit may control the light emitter to illuminate the second detection area with light.

According to one or more embodiments of the present invention, a power supply control method includes: setting a first detection area positioned outside of a housing of an image forming apparatus and a second detection area contained in the first detection area and located adjacent to the housing; controlling a light emitter to emit light when a person is detected in the first detection area; and controlling a power supply to start terminating a power saving mode when the person is detected in the second detection area.

In the power supply control method according to one or more embodiments, the controlling the light emitter to illuminate with light may include controlling the light emitter to illuminate the second detection area with light when the person is detected in a third detection area that is an area excluding the second detection area from the first detection area.

In the power supply control method according to one or more embodiments, the controlling the light emitter to illuminate the second detection area with light may include controlling the light emitter to emit light toward a floor surface in the second detection area.

In the power supply control method according to one or more embodiments, the controlling the light emitter to illuminate the second detection area with light may include controlling the light emitter to draw a marker indicating a direction to the housing from a position of the person in the second direction area, the marker following movement of the person.

In the power supply control method according to one or more embodiments may include: determining on whether the person has moved from outside of the first detection area to the third detection area or from the second detection area to the third detection area when the human detecting unit detects a person in the third detection area; controlling the light emitter to illuminate the second detection area with light when it is determined that the person has moved from outside of the first detection area to the third detection area; and controlling the light emitter not to illuminate the second detection area when it is determined that the person has moved from the second detection area to the third detection area.

In the power supply control method according to one or more embodiments, the controlling to start terminating the power saving mode may include controlling the power supply to start termination of the power saving mode when the person is detected in the second detection area and another person is detected in the third detection area at the same time.

In the power supply control method according to one or more embodiments, the controlling the light emitter to illuminate the second detection area with light may include controlling the light emitter to illuminate the second detection area with light when it is determined that the person has moved from the second detection area to the third detection area and another person has moved from outside of the first detection area to the third detection area.

According to one or more embodiments of the present invention, a power supply control program causes a computer to execute the power supply control method according to one or more embodiments.

According to one or more embodiments of the present invention, a non-transitory recording medium storing a computer readable program causes a computer to execute the power supply control method according to one or more embodiments.

### BRIEF DESCRIPTION OF THE DRAWINGS

Embodiments of the present invention will become more fully understood from the detailed description given hereinbelow and the appended drawings which are given by way of illustration only, and thus are not intended as a definition of the limits of the present invention, and wherein:

FIG. 1 is a schematic front view of an image forming apparatus according to a first embodiment of the present invention;

FIG. 2 is a schematic block diagram for explaining a device configuration of the image forming apparatus illustrated in FIG. 1;

FIG. 3 is a schematic view of a human detection area and a power saving termination area set for the image forming apparatus illustrated in FIG. 1 as viewed from above the image forming apparatus;

FIG. 4 is a schematic block diagram illustrating a configuration of a control unit in FIG. 1;

FIG. 5A is a flowchart for explaining an outline of a power supply control method according to examples of the first embodiment of the present invention;

FIG. 5B is a flowchart following FIG. 5A;

FIG. 6A is a schematic view for explaining a first example of the power supply control method illustrated in FIGS. 5A and 5B;

FIG. 6B is a schematic view following FIG. 6A;

FIG. 6C is a schematic view following FIG. 6B;

FIG. 7A is a schematic view for explaining a second example of the power supply control method illustrated in FIGS. 5A and 5B;

FIG. 7B is a schematic view following FIG. 7A;

FIG. 8A is a schematic view for explaining a third example of the power supply control method illustrated in FIGS. 5A and 5B;

FIG. 8B is a schematic view following FIG. 8A;

FIG. 8C is a schematic view for explaining the third example of the power supply control method illustrated in FIGS. 5A and 5B;

FIG. 9A is a schematic view for explaining a fourth example of the power supply control method illustrated in FIGS. 5A and 5B;

FIG. 9B is a schematic view following FIG. 9A;

FIG. 9C is a schematic view following FIG. 9B;

FIG. 10A is a schematic view for explaining a fifth example of the power supply control method illustrated in FIGS. 5A and 5B;

FIG. 10B is a schematic view following FIG. 10A;

FIG. 10C is a schematic view following FIG. 10B;

FIG. 11 is a flowchart for explaining an outline of a power supply control method according to examples of a second embodiment of the present invention;

FIG. 12A is a schematic view for explaining a sixth example of the power supply control method illustrated in FIG. 11;

FIG. 12B is a schematic view following FIG. 12A;

FIG. 13 is a flowchart for explaining an outline of a power supply control method according to examples of a third embodiment of the present invention;

FIG. 14A is a schematic view for explaining a seventh example of the power supply control method illustrated in FIG. 13;

FIG. 14B is a schematic view following FIG. 14A;

FIG. 15 is a flowchart for explaining an outline of a power supply control method according to examples of a fourth embodiment of the present invention;

FIG. 16A is a schematic view for explaining an eighth example of the power supply control method illustrated in FIG. 15;

FIG. 16B is a schematic view following FIG. 16A;

FIG. 16C is a schematic view following FIG. 16B;

FIG. 16D is a schematic view following FIG. 16C;

FIG. 17 is a flowchart for explaining an outline of a power supply control method according to examples of a fifth embodiment of the present invention;

FIG. 18A is a schematic view for explaining a ninth example of the power supply control method illustrated in FIG. 17;

FIG. 18B is a schematic view following FIG. 18A; and

FIG. 18C is a schematic view following FIG. 18B.

### DETAILED DESCRIPTION OF EMBODIMENTS

Hereinafter, an image forming apparatus, a power supply control method, and a power supply control program according to one or more embodiments of the present invention will be described with reference to the drawings. However, the scope of the invention is not limited to the illustrated examples. In the drawings, the same components will be designated by the same reference numerals. In addition, ratios of dimensions in the drawings are exaggerated for convenience of explanation, and may be different from actual ratios.

### First Embodiment

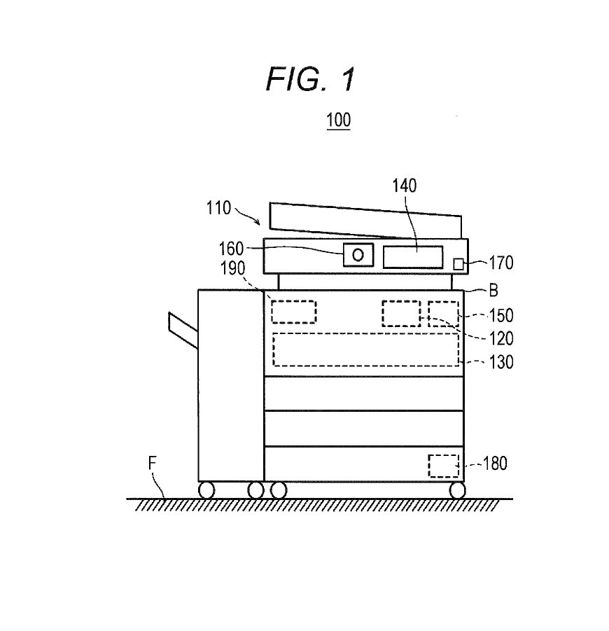

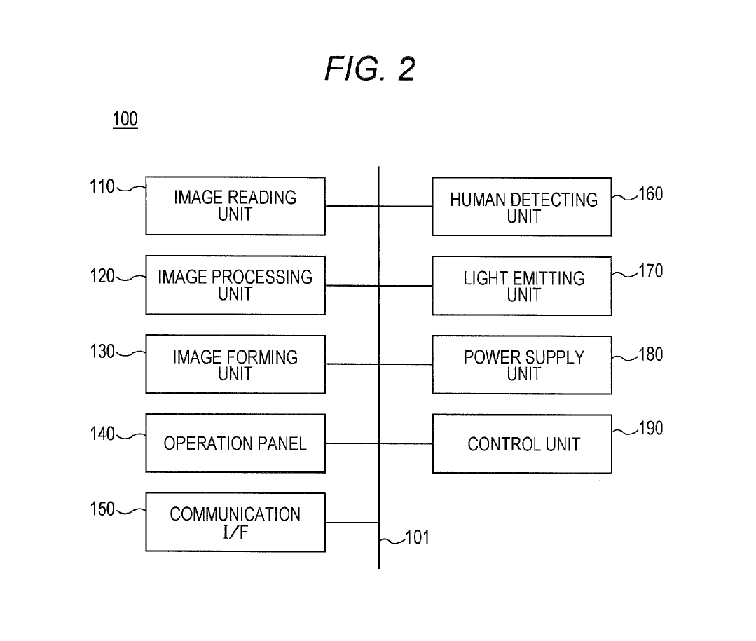

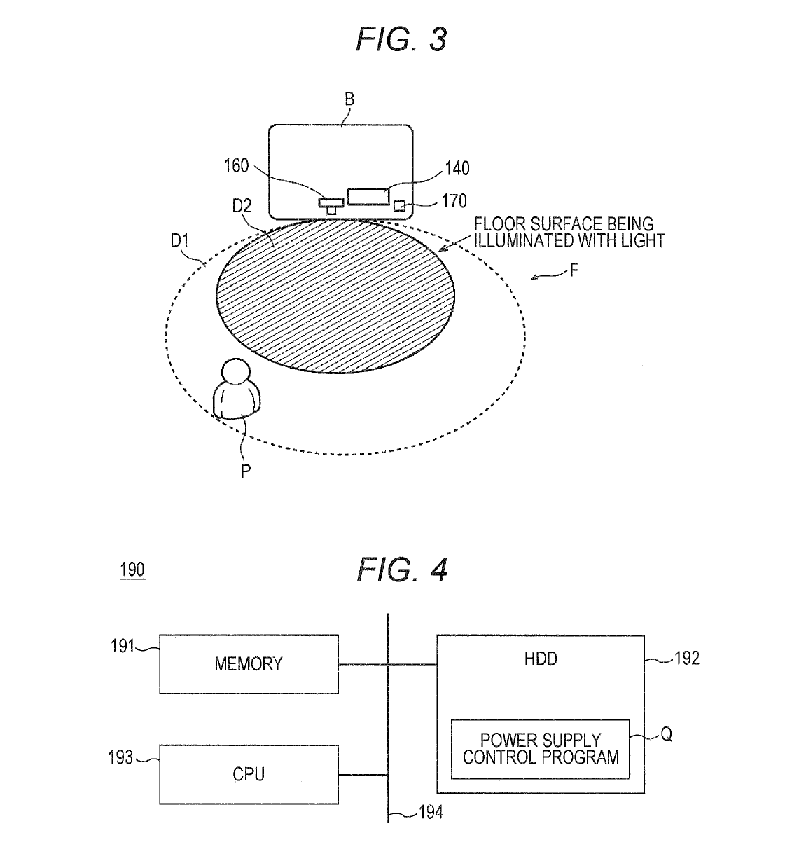

FIG. 1 is a schematic front view of an image forming apparatus according to examples of a first embodiment of the present invention, and FIG. 2 is a schematic block diagram for explaining a device configuration of the image forming apparatus illustrated in FIG. 1. In addition, FIG. 3 is a schematic view of a human detection area and a power saving termination area set for the image forming apparatus illustrated in FIG. 1 as viewed from above the image forming apparatus. FIG. 4 is a schematic block diagram illustrating a configuration of a control unit in FIG. 1.

In examples of the present embodiment, an example in which the image forming apparatus is a multifunction peripheral (MFP) will be described. The image forming apparatus, however, may be a copying machine, a facsimile machine, a printer, or the like.

<Configuration of Image Forming Apparatus>

As illustrated in FIG. 1, the image forming apparatus (hereinafter referred to as a “MFP”) 100 according to examples of the present embodiment has a housing B provided with an image reading unit 110 (may be referred to as “an image reader”), an image processing unit 120 (may be referred to as “an image processor), an image forming unit 130 (may be referred to as “an image former”), an operation panel 140, a communication interface (I/F) 150, a human detecting unit 160 (may be referred to as “a human detector”), a light emitting unit 170 (may be referred to as “a light emitter”), a power supply unit 180 (may be referred to as “a power supply”), and a control unit 190 (may be referred to as “a controller”).

As illustrated in FIG. 2, the components, which are the image reading unit 110, the image processing unit 120, the image forming unit 130, the operation panel 140, the communication I/F 150, the human detecting unit 160, the light emitting unit 170, the power supply unit 180, and the control unit 190, are connected to one another via an internal bus 101 in such a manner that the components can communicate with one another.

<Image Reading Unit>

The image reading unit 110 optically reads an original document placed on an automatic document feeder (ADF), and generates an image data signal. The image reading unit 110 includes a light source, an optical system, an image sensor, and an analog-to-digital conversion circuit. In the image reading unit 110, the light source emits light rays of R, G, and B sequentially toward the original document. The optical system has multiple mirrors and an imaging lens. Reflected light rays from the original document are focused onto the image sensor via the mirrors and the imaging lens of the optical system. The image sensor reads the reflected light rays corresponding to the colors R, G, and B line by line, and generates an electrical signal according to the intensities of reflected light rays from the original document. The generated electrical signal is converted from an analog signal to a digital signal by the analog-to-digital conversion circuit, and transmitted as an image data signal to the image processing unit 120.

<Image Processing Unit>

The image processing unit 120 generates printed image data. The image processing unit 120 applies various image processing techniques such as shading compensation and γ correction to the image data signal generated by the image reading unit 110 to generate printed image data in bitmap format.

Furthermore, the image processing unit 120 includes a rasterizing unit, and generates the printed image data on the basis of print setting and print data contained in a print job received by the communication I/F 150. The generated printed image data are transmitted to the control unit 190 and stored in a memory.

<Image Forming Unit>

The image forming unit 130 forms an image by an electrophotographic process, an electrostatic recording method, or the like, and fixes the formed image onto a sheet that is a recording medium. Specifically, the image forming unit 130 irradiates a photosensitive member with light with use of light emitting elements such as lasers or light emitting diodes (LEDs) to form an electrostatic latent image based on the printed image data stored in the memory of the control unit 190. Subsequently, the image forming unit 130 charges the photosensitive member having the electrostatic latent image formed thereon, so that toner adheres to the surface of the photosensitive member and forms a toner image, and transfers the toner image onto the sheet with use of a transfer belt. The sheet onto which the toner image has been transferred is conveyed to a fixing device, and heated under pressure, so that the toner image is adhered onto the sheet. The sheet onto which the toner image is adhered is conveyed to a post-processing device.

<Operation Panel>

The operation panel 140 receives user's instructions and displays messages and the like for the user. In examples of the present embodiment, the operation panel 140 has button switches and a touch panel attached to the housing B. The user operates these button switches and touch screens displayed on the touch panel to input instructions to the MFP 100. The touch screens display input information, various setting information data, warning messages, and the like.

<Communication I/F>

The communication I/F 150 is an interface for communication with devices such as client terminals connected to a network. The communication I/F 150 receives a print job from a client terminal, and sends the received print job to the image processing unit 120.

For the communication I/F 150, a network interface based on a standard such as Ethernet (registered trademark), Token Ring, or FDDI, and in addition, various types of local interface such as a serial interface such as a universal serial bus (USB) or based on IEEE 1394 or the like, a parallel interface based on SCSI, IEEE 1284 or the like, a wireless communication interface based on Bluetooth (registered trademark), IEEE 802.11, HomeRF, IrDA and the like, and a telephone line interface for connection to a telephone line, etc. can be used.

<Human Detecting Unit>

As illustrated in FIG. 3, the human detecting unit 160 detects a person around the MFP 100. More specifically, the human detecting unit 160 detects a person who is present within a human detection area (first detection area) D1 set outside of the housing B of the MFP 100. The human detection area D1 can be a spatial area around the housing B. In FIG. 3, an example of a boundary of the human detection area D1 as viewed from above the MFP 100 is shown by a broken line. The inside of the boundary is the human detection area D1, and the outside of the boundary is a non detection area.

Note that the shape and the size of the human detection area D1 are not limited. The shape of the human detection area D1 can be a circle, an oval, a fan-like shape, or a rectangle, for example. The human detection area D1 can be set to a range of several meters, or more preferably to a range of 2 to 3 meters, for example, from the position of the MFP 100 depending on the surrounding environment in which the MFP 100 is installed.

In examples of the present embodiment, the human detecting unit 160 includes an imager (video camera) as a sensor. The imager may be attached to the front of the housing B of the MFP 100 (the near side of the drawing in FIG. 1). This is because a person P who is going to use the MFP 100 is likely to approach the MFP 100 from the front side of the housing B on which the operation panel 140 is attached.

Note that the shooting range of the imager may be such a range that movement of a person can be taken in a range within a radius of several meters from about the operation panel 140 of the MFP 100, and may be such a range that the floor surface F on which the MFP 100 is installed can also be taken.

Although an example in which the imager is used as the sensor of the human detecting unit 160 to detect a person will be described below, the human detecting unit 160 is not limited to an imager, but a pyroelectric infrared sensor, for example, may be used to detect a person. When a pyroelectric infrared sensor is used, the human detecting unit 160 can include a first sensor for detecting the human detection area D1 and a second sensor for detecting a power saving termination area (second detection area) D2, which will be described later, for example.

<Light Emitting Unit>

The light emitting unit 170 illuminates the power saving termination area D2 with light. As illustrated in FIG. 3, the power saving termination area D2 is an area contained in the human detection area D1 and located adjacent to the housing B. The power saving termination area D2 can be a spatial area around the housing B. In examples of the present embodiment, the light emitting unit 170 includes a projector with a light source such as a laser pointer or a laser. The light emitting unit 170 emits light while scanning the inside of or on the boundary of an area where the power saving termination area D2 intersects with the floor surface F, so that the floor surface F in the power saving termination area D2 is illuminated with light, to indicate the range of the power saving termination area D2 to the user.

Note that the shape and the size of the power saving termination area D2 is not limited. The shape of the power saving termination area D2 can be a circle, an oval, a fan-like shape, or a rectangle, for example. The power saving termination area D2 can be set in view of the time taken for the MFP 100 to return from a power saving mode to a normal mode and the time for the user to reach the front of the MFP 100 after entering the power saving termination area D2 so that the user need not be kept waiting in front of the MFP 100. The power saving termination area D2 may have a size sufficient for the user not to be kept waiting in front of the MFP 100 and as small as possible in terms of reducing power consumption of the laser. More specifically, the power saving termination area D2 may be set within a range of several centimeters to two meters from the position of the MFP 100, for example.

<Power Supply Unit>

The power supply unit 180 distributes power supplied from a commercial power supply (not illustrated) to the components, which are the image reading unit 110, the image processing unit 120, the image forming unit 130, the operation panel 140, the communication I/F 150, the human detecting unit 160, the light emitting unit 170, and the control unit 190.

The MFP 100 of examples of the present embodiment has a power saving function, and can reduce power consumption while the MFP 100 is not being used. In examples of the present embodiment, the power supply unit 180 supplies power in a power supply mode among multiple power supply modes including the “normal mode” and the “power saving mode.”

In the normal mode, the power supply unit 180 supplies power sufficient for image formation by the image forming unit 130 to the components. In the power saving mode, the power supply unit 180 supplies minimum power to the components of the MFP 100 so that the power supply is less than that in the normal mode. In the power saving mode, in order to reduce power consumption, some of the functions used in normal operation such as touch panel screen display on the operation panel 140 and image formation by the image forming unit 130, for example, are suspended. Note that power is supplied to part of the communication I/F 150, the human detecting unit 160, the light emitting unit 170, and the control unit 190 even during operation in the power saving mode.

Herein, a state in which the MFP 100 operates in the power saving mode will be referred to as a “power saving state.” The MFP 100 in the power saving state terminates the power saving mode and returns to the normal mode, which is triggered by user's operation on the operation panel 140, reception of a print job from a client terminal connected via a network, or the like. Herein, a state in which the MFP 100 operates in the normal mode will be referred to as a “power saving termination state.”

<Control Unit>

The control unit 190 controls the image reading unit 110, the image processing unit 120, the image forming unit 130, the operation panel 140, the communication I/F 150, the human detecting unit 160, the light emitting unit 170, and the power supply unit 180.

As illustrated in FIG. 4, the control unit 190 includes a memory 191, a hard disk drive (HDD) 192, and a central processing unit (CPU) 193, which are connected to one another via an internal bus 194.

The memory 191 includes a random access memory (RAM) and a read only memory (ROM), and stores printed image data generated by the image processing unit 120, processing results, parameters, and the like.

The HDD 192 stores therein an operating system, various application programs, control programs for controlling the MFP 100, and the like.

In examples of the present embodiment, in particular, a power supply control program Q for controlling power supply is stored as a control program in the HDD 192. The power supply control program Q is configured to make the CPU 193 execute a power supply control method, which will be described later.

The control unit 190 sets the human detection area D1 located outside of the housing B, and the power saving termination area D2 contained in the human detection area D1 and located adjacent to the housing B. Note that the control unit 190 can also register the shapes and the sizes of the human detection area D1 and the power saving termination area D2 as data in the memory 191, and update the registered data in response to user's request. This allows the shapes and the sizes of the human detection area D1 and the power saving termination area D2 to be changed as necessary according to a change in the surrounding environment of the position where the MFP 100 is installed or user's preference, for example.

When the human detecting unit 160 has detected a person in the human detection area D1, the control unit 190 controls the light emitting unit 170 to emit light in such a manner that the user can recognize the power saving termination area D2. Furthermore, when the human detecting unit 160 has detected a person in the power saving termination area D2, the control unit 190 performs control to start terminating the power saving mode.

<Outline of Power Supply Control Method>

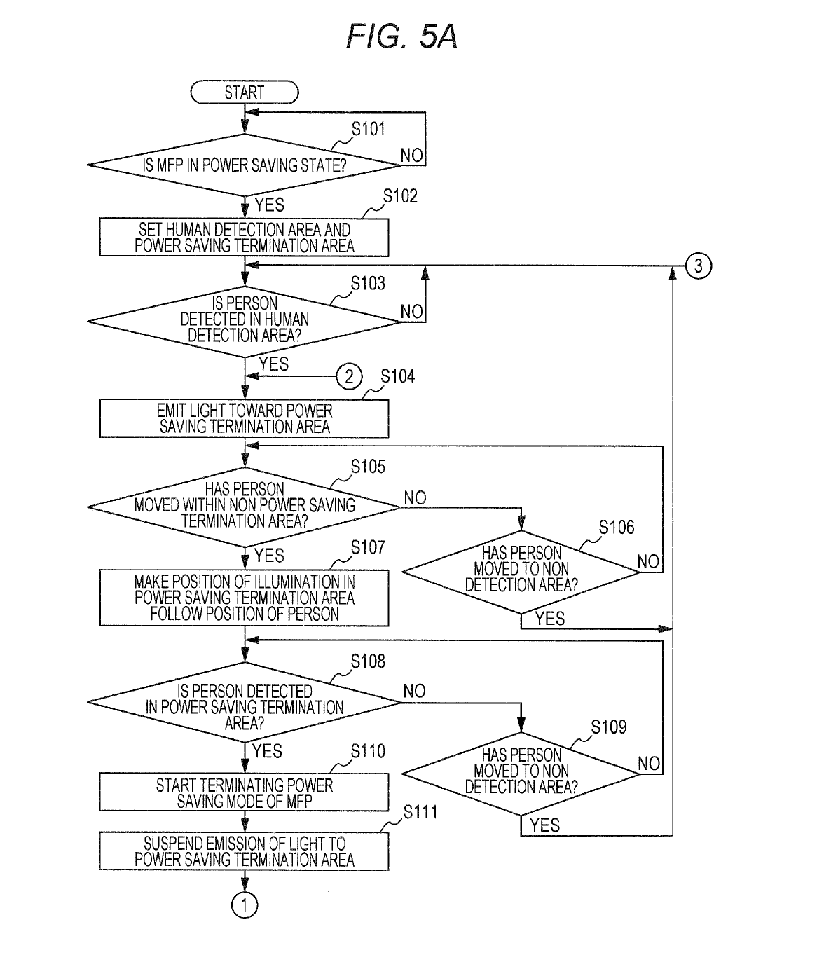

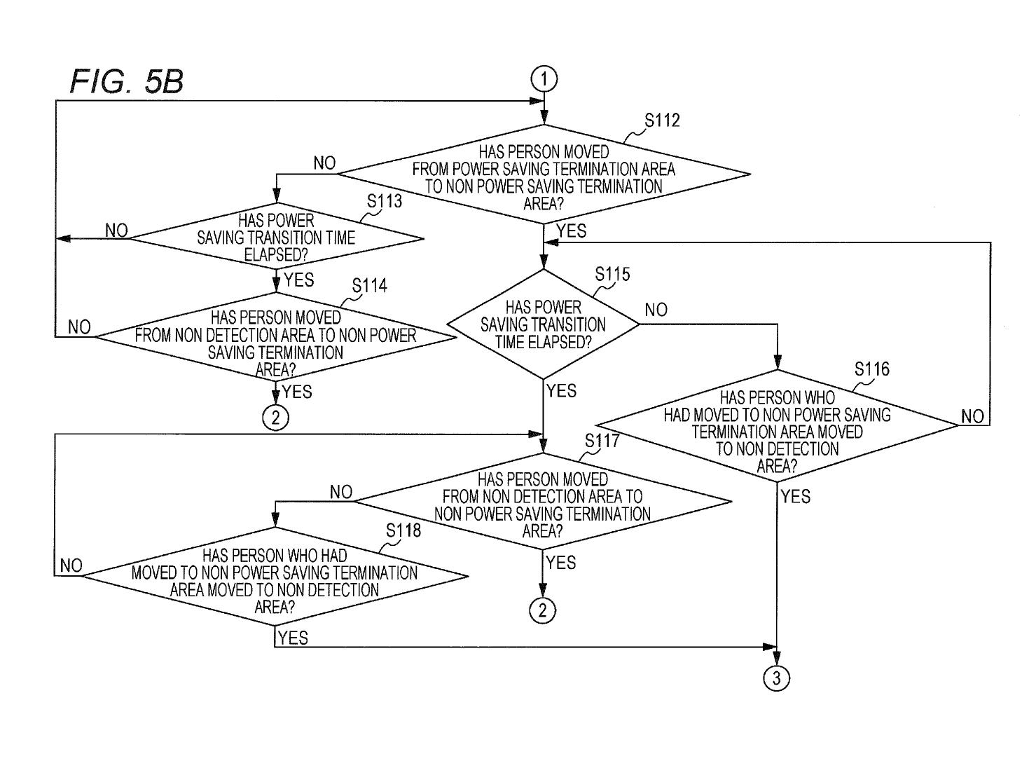

Hereinafter, an outline of the power supply control method according to examples of the first embodiment of the present invention will be described with reference to FIGS. 5A and 5B. FIGS. 5A and 5B are flowcharts for explaining the outline of the power supply control method according to examples of the first embodiment of the present invention. The control unit 190 executes the power supply control program Q stored in the HDD 192 to perform processes in the flowcharts illustrated in FIGS. 5A and 5B.

As illustrated in FIG. 5A, first, the MFP 100 waits until the MFP 100 enters a power saving state (step S101). If the MFP 100 is in the power saving state (step S101: YES), the human detection area D1 and the power saving termination area D2 are set (step S102). The control unit 190 turns on the imager of the human detecting unit 160, and sets the human detection area D1 located outside of the housing B of the MFP 100 and the power saving termination area D2 contained in the human detection area D1 and located adjacent to the housing B. The imager of the human detecting unit 160 starts taking a picture of the human detection area D1.

Subsequently, the MFP 100 waits until a person is detected in the human detection area D1 (step S103). Specifically, the imager of the human detecting unit 160 takes a picture of the human detection area D1, performs image processing on the video picture to determine the position of a person in the video picture, and determines whether or not a person is present in the human detection area D1. Since a known processing method can be applied as a specific method for image processing of the video picture, detailed description thereof is omitted.

If a person is detected in the human detection area D1 (step S103: YES), light is emitted toward the power saving termination area D2 (step S104). More specifically, the light emitting unit 170 emits laser light toward the floor surface F in the power saving termination area D2 to illuminate the floor surface F in the power saving termination area D2 with the light.

Note that the laser light is emitted so that a person (user) entering the human detection area D1 can recognize (perceive) the power saving termination area D2 at a glance. For example, in examples of the present embodiment, laser light can be emitted to the entire floor surface F within the power saving termination area D2 as illustrated in FIG. 3. Alternatively, laser light may be emitted onto the boundary of the floor surface F in the power saving termination area D2. Still alternatively, light may be emitted to an area outside of the power saving termination area D2 so that the user can recognize the power saving termination area D2.

Subsequently, it is determined whether or not a person has moved within a non power saving termination area (step S105). The non power saving termination area (third detection area) in examples of the present embodiment is an area excluding the power saving termination area D2 from the human detection area D1.

If a person has not moved within the non power saving termination area (step S105: NO), it is determined whether or not a person has moved to the non detection area (step S106). If a person has moved to the non detection area (step S106: YES), the method proceeds to the process in step S103. If a person has not moved to the non detection area (step S106: NO), the method proceeds to the process in step S105 again.

If a person has moved within the non power saving termination area (step S105: YES), the position of illumination in the power saving termination area D2 is made to follow the position of the person (step S107). A specific example of making the position of illumination in the power saving termination area D2 follow the position of a person will be described later with reference to examples.

Subsequently, it is determined whether or not a person is detected in the power saving termination area D2 (step S108). The control unit 190 analyzes a video picture taken by the imager of the human detecting unit 160 to determine whether or not a person is detected in the power saving termination area D2. If no person is detected in the power saving termination area D2 (step S108: NO), it is determined whether or not a person has moved to the non detection area (step S109). If a person has moved to the non detection area (step S109: YES), the method proceeds to the process in step S103. If a person has not moved to the non detection area (step S109: NO), the method proceeds to the process in step S108 again.

If a person is detected in the power saving termination area D2 (step S108: YES), termination of the power saving mode of the MFP 100 is started (step S110). The control unit 190 performs control to terminate the power saving mode and return to the normal mode.

Subsequently, emission of light to the power saving termination area D2 is suspended (step S111). The control unit 190 performs control to suspend radiation of laser light to the light emitting unit 170.

Subsequently, as illustrated in FIG. 5B, it is determined whether or not a person has moved from the power saving termination area D2 to the non power saving termination area (step S112). If a person has not moved from the power saving termination area D2 to the non power saving termination area (step S112: NO), it is determined whether or not a power saving transition time has elapsed (step S113). The power saving transition time in examples of the present embodiment is a time period from when the MFP 100 is switched to the normal mode to when the MFP 100 is switched to the power saving mode again. If the power saving transition time has not elapsed (step S113: NO), the method proceeds to the process in step S112 again. If the power saving transition time has elapsed (step S113: YES), it is determined whether or not a person has moved from the non detection area to the non power saving termination area (step S114). If a person has not moved from the non detection area to the non power saving termination area (step S114: NO), the method proceeds to the process in step S112. If a person has moved from the non detection area to the non power saving termination area (step S114: YES), the method proceeds to the process in step S104 in FIG. 5A.

If a person has moved from the power saving termination area D2 to the non power saving termination area (step S112: YES), it is determined whether or not the power saving transition time has elapsed (step S115). If the power saving transition time has not elapsed (step S115: NO), it is determined whether or not the person who had moved to the non power saving termination area has moved to the non detection area (step S116). If the person who had moved to the non power saving termination area has not moved to the non detection area (step S116: NO), the method proceeds to the process in step S115 again. If the person who had moved to the non power saving termination area has moved to the non detection area (step S116: YES), the method proceeds to the process in step S103 in FIG. 5A.

If the power saving transition time has elapsed (step S115: YES), it is determined whether or not a person has moved from the non detection area to the non power saving termination area (step S117). If a person has moved from the non detection area to the non power saving termination area (step S117: YES), the method proceeds to the process in step S104 in FIG. 5A. If a person has not moved from the non detection area to the non power saving termination area (step S117: NO), it is determined whether or not the person who had moved to the non power saving termination area has moved to the non detection area (step S118). If the person who had moved to the non power saving termination area has moved to the non detection area (step S118: YES), the method proceeds to the process in step S103 in FIG. 5A. If the person who had moved to the non power saving termination area has moved to the non detection area (step S118: NO), the method proceeds to the process in step S117 again.

### EXAMPLES

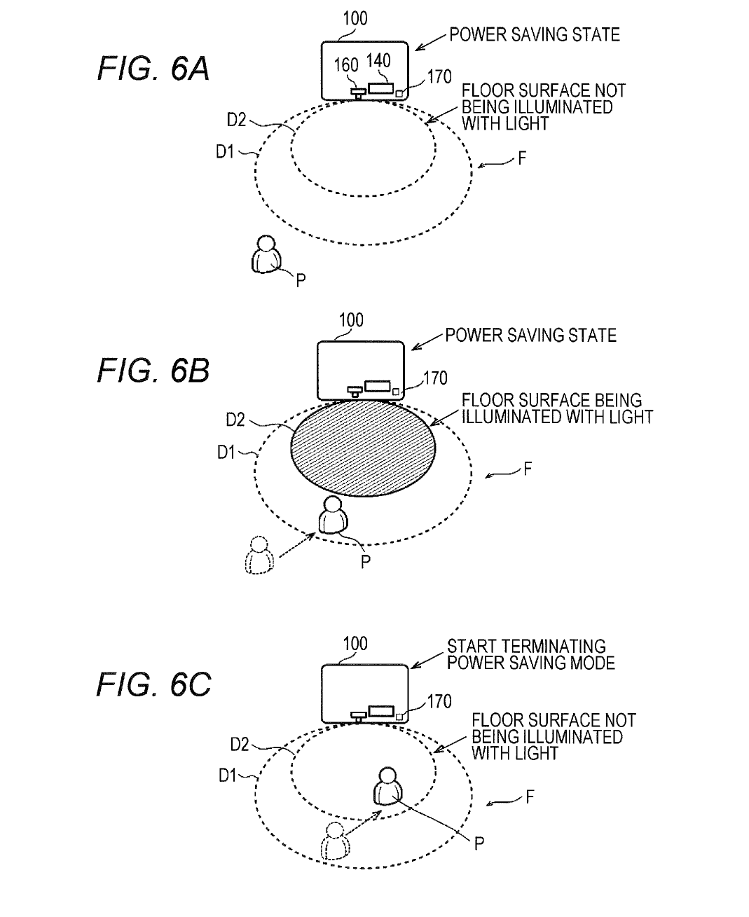

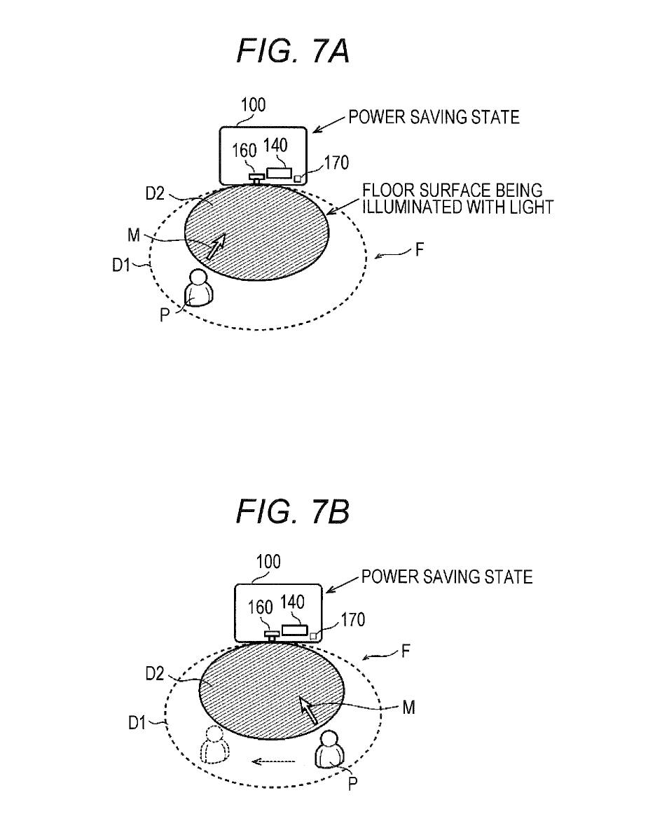

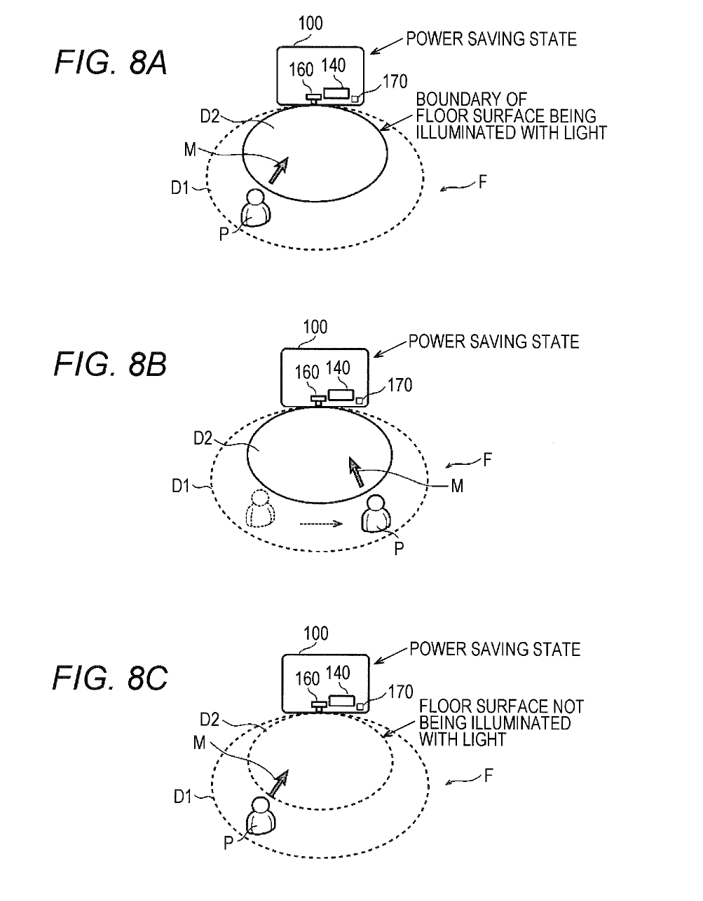

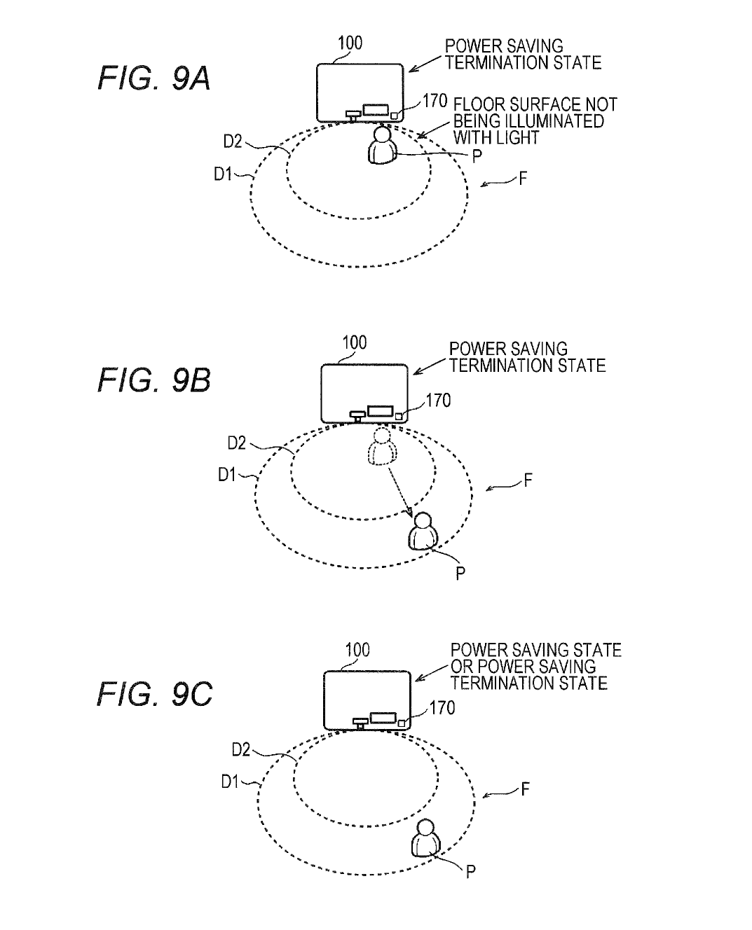

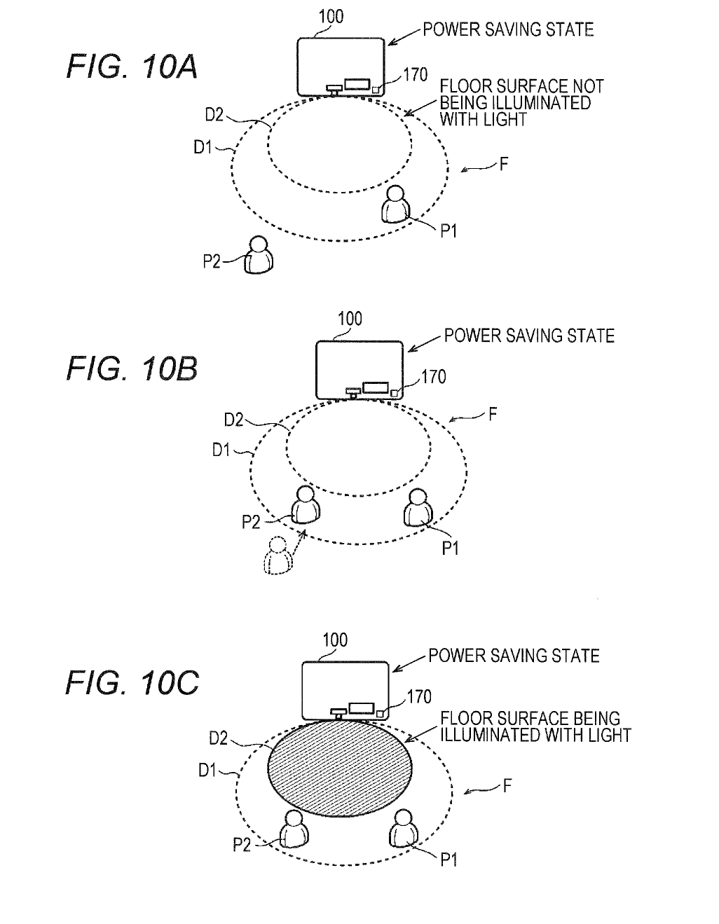

The outline of the power supply control method according to examples of the present embodiment has been described above with reference to FIGS. 5A and 5B. Hereinafter, examples of the power supply control method according to examples of the present embodiment will be described with reference to FIGS. 6A to 10C. FIGS. 6A to 6C are schematic views for explaining a first example of the power supply control method illustrated in FIGS. 5A and 5B, and FIGS. 7A and 7B are schematic views for explaining a second example of the power supply control method illustrated in FIGS. 5A and 5B. FIGS. 8A to 8C are schematic views for explaining a third example of the power supply control method illustrated in FIGS. 5A and 5B, and FIGS. 9A to 9C are schematic views for explaining a fourth example of the power supply control method illustrated in FIGS. 5A and 5B. Furthermore, FIGS. 10A to 10C are schematic views for explaining a fifth example of the power supply control method illustrated in FIGS. 5A and 5B.

### First Example

In the first example, a case in which a person P present in the non detection area approaches the MFP 100 to use the MFP 100 will be described.

As illustrated in FIG. 6A, the control unit 190 turns on the imager of the human detecting unit 160, and sets the human detection area D1 located outside of the housing B of the MFP 100 and the power saving termination area D2 contained in the human detection area D1 and located adjacent to the housing B. Initially, the MFP 100 is in the power saving state and the person P is in the non detection area. Thus, the person P is not detected in the human detection area D1 by the human detecting unit 160 (step S103: NO). As a result, the control unit 190 does not perform control on the light emitting unit 170 to emit laser light toward the floor surface F in the power saving termination area D2, and thus the floor surface F in the power saving termination area D2 is not illuminated with light.

Subsequently, as illustrated in FIG. 6B, the person P enters the human detection area D1. The person P is detected in the human detection area D1 by the human detecting unit 160 (step S103: YES). The control unit 190 controls the light emitting unit 170 to emit laser light toward the floor surface F in the power saving termination area D2, so as to illuminate the floor surface F in the power saving termination area D2 with light (step S104). The MFP 100 is maintained in the power saving state.

Subsequently, as illustrated in FIG. 6C, the person P further enters the power saving termination area D2. The person P is detected in the power saving termination area D2 (step S108: YES). The control unit 190 starts terminating the power saving mode of the MFP 100 (step S110). The control unit 190 also suspends emission of light to the power saving termination area D2 (step S111).

As described above, in the first example illustrated in FIGS. 6A to 6C, the control unit 190 first sets the human detection area D1 and the power saving termination area D2. The human detection area D1 is an area located outside of the housing B of the MFP 100, and the power saving termination area D2 is an area contained in the human detection area D1 and located adjacent to the housing B. Subsequently, when the person P enters the human detection area D1, the human detecting unit 160 detects the person P present in the human detection area D1. When the person P is detected in the human detection area D1, the control unit 190 controls the light emitting unit 170 to illuminate the power saving termination area D2 with light. When the person P then enters the power saving termination area D2, the human detecting unit 160 detects the person P present in the power saving termination area D2. If the person P is detected in the power saving termination area D2, the control unit 190 starts terminating the power saving mode. As a result, switching to the normal mode is started at an earlier stage than a case in which switching to the normal mode is started only after a button or the like on the operation panel 140 is operated. This produces an effect that the waiting time until the MFP 100 becomes able to be used in the normal mode can be shortened. The control unit 190 then controls the light emitting unit 170 to suspend emission of light to the power saving termination area D2.

### Second Example

In the second example, a case in which a person present in the non power saving termination area moves within the non power saving termination area without going toward the power saving termination area and a marker is drawn following the movement of the person will be described.

As illustrated in FIGS. 7A and 7B, when the person P has moved within the non power saving termination area (step S105: YES), the control unit 190 controls the light emitting unit 170 to make the position of a marker M illuminating the power saving termination area D2 follow the position of the person (step S107).

The marker M is drawn in such a form that allows the person P present in the non power saving termination area to easily recognize the direction toward the installation position of the MFP 100 from the position of the person P. In the present example, a marker M in the shape of an arrow pointing the MFP 100 from the position of the person P is drawn on the floor surface F in the power saving termination area D2. Note that the shape of the marker M may be a shape other than an arrow.

The marker M may be drawn in a color different from that of the other part of the power saving termination area D2 other than the marker M so that the marker M can be easily distinguished from the other part. Alternatively, a part (having an arrow shape, for example) that is not illuminated with laser light may be generated on the floor surface F in the power saving termination area D2 and used as the marker M.

As described above, in the second example illustrated in FIGS. 7A and 7B, the control unit 190 controls the light emitting unit 170 to change the position of light emission on the floor surface F in the second detection area D2 according to the position of the person P. More specifically, the control unit 190 controls the light emitting unit 170 to draw the marker M pointing the direction toward the housing B of the MFP 100 from the position of the person P following the movement of the person P within the non power saving termination area.

Note that the human detection area D1 and the power saving termination area D2 in examples of the present embodiment are not limited to the shapes illustrated in FIGS. 7A and 7B.

### Third Example

In the second example, the case in which the entire floor surface in the power saving termination area is illuminated with light and a marker is drawn following the movement of the person has been described. In the third example, a case in which the entire floor surface in the power saving termination area is not illuminated with light but a marker is drawn following the movement of a person will be described.

As illustrated in FIGS. 8A and 8B, when the person P has moved within the non power saving termination area (step S105: YES), the control unit 190 controls the light emitting unit 170 to make the drawing position of a marker M follow the position of the person P while illuminating the boundary of the floor surface F in the power saving termination area D2 (step S107).

Alternatively, as illustrated in FIG. 8C, the position and the size of the marker M may be changed according to the position of the person P moving within the non power saving termination area without illumination on or inside the boundary of the floor surface F in the power saving termination area D2. Thus, as a result of drawing a marker following the position of the person P, the marker M can be made to have a role of indicating the range of the power saving termination area D2. As a result, the area of laser illumination becomes smaller, and thus power consumption can further be reduced. Note that one end of the marker M (the base of the arrow in FIG. 8C) may be positioned along the boundary between the non power saving termination area and the power saving termination area D2.

### Fourth Example

In the fourth example, a case in which a person present in the power saving termination area moves to the non power saving termination area will be described.

As illustrated in FIG. 9A, the person P is in the power saving termination area D2 and operates the MFP 100. Since the person P is in the power saving termination area D2, the MFP 100 is in the power saving termination state.

Subsequently, as illustrated in FIG. 9B, the person P who had been in the power saving termination area D2 moves to the non power saving termination area (step S112: YES). The MFP 100 is still in the power saving termination state immediately after the person P moved to the non power saving termination area. In the present example, when the person who had been in the power saving termination area D2 has moved to the non power saving termination area, the floor surface F in the power saving termination area D2 is not illuminated with light.

Then, as illustrated in FIG. 9C, when the power saving transition time has elapsed since the person P moved to the non power saving termination area, the MFP 100 enters the power saving mode and is brought into a power saving state.

### Fifth Example

The fifth example is an example following the fourth example. In the fifth example, a case in which a person moves from the non detection area to the non power saving termination area in a state in which another person who moved from the power saving termination area to the non power saving termination area is present.

As illustrated in FIG. 10A, a person P1 who had moved from the power saving termination area D2 is present in the non power saving termination area, and another person P2 is present in the non detection area. Since no person is present in the power saving termination area D2 at this point, the MFP 100 is in the power saving state.

Subsequently, as illustrated in FIG. 10B, the person P2 moves from the non detection area to the non power saving termination area in a state in which the person P1 who moved from the power saving termination area D2 to the non power saving termination area is present.

As illustrated in FIG. 10C, since the person P2 has moved from the non detection area to the non power saving termination area, the control unit 190 then controls the light emitting unit 170 to emit light toward the power saving termination area D2. The floor surface F in the power saving termination area D2 is thus illuminated with light. In other words, even after the person P1 moved from the power saving termination area D2 to the non power saving termination area, if the person P2 who has moved from the non detection area to the non power saving termination area is present, priority is given to the person P2 and light is emitted toward the floor surface F in the power saving termination area D2.

As described above, in examples of the present embodiment, when the human detecting unit 160 has detected a person P who has moved from the non detection area to the non power saving termination area, the control unit 190 controls the light emitting unit 170 to illuminate the power saving termination area D2 with light. Furthermore, when the human detecting unit 160 has detected a person P in the power saving termination area D2, the control unit 190 controls the light emitting unit 170 to suspend light emission to the power saving termination area D2.

Alternatively, in examples of the present embodiment, illumination of the power saving termination area D2 with light may be continued without being suspended after a person P moved from the non power saving termination area to the power saving termination area D2. In this case, the control unit 190 performs control so that laser light will not emitted toward the person P.

Furthermore, the power saving termination area D2 may also be illuminated with light when it is detected that a person has moved from the non detection area to the power saving termination area D2 without passing through the non power saving termination area. For example, when a person enters the human detection area D1 from a side of the MFP 100, the person can move from the non detection area to the power saving termination area D2 without passing through the non power saving termination area since the power saving termination area D2 is close to the boundary between the non detection area and the human detection area D1 in the vicinity of the MFP 100.

Furthermore, the power saving termination area D2 may be illuminated with light when a person is detected in the human detection area D1 whether the person is present in the non power saving termination area or the power saving termination area D2.

The image forming apparatus, the power supply control method, and the power supply control program according to examples of the present embodiment described above produces the following advantageous effects.

Since the area in which the power saving mode is terminated is illuminated with light in the surrounding area of the MFP 100, it is possible to notify a person around the MFP 100 of the area in which the power saving mode is terminated. A person who does not intend to use the MFP 100 is thus prevented from accidentally stepping into the area in which the power saving mode is terminated, which can thus prevent the power saving mode from being uselessly terminated. As a result, the MFP 100 can be prevented from wastefully consuming power, which thus prevents the power consumption reducing effect of the power saving functions from being undermined.

### Second Embodiment

In examples of the first embodiment, a description has been made on controlling the light emitting unit so that power saving termination area is illuminated with light when the human detecting unit has detected a person. In examples of a second embodiment, a description will be made on providing a limit to the time during which the power saving termination area is illuminated with light.

Since configurations in examples of the present embodiment corresponding to those illustrated in FIGS. 1, 2, and 4 of examples of the first embodiment are the same as those in FIGS. 1, 2, and 4, the description thereof will not be repeated. Furthermore, in the following description, detailed description of part that overlaps with examples of the first embodiment will not be repeated.

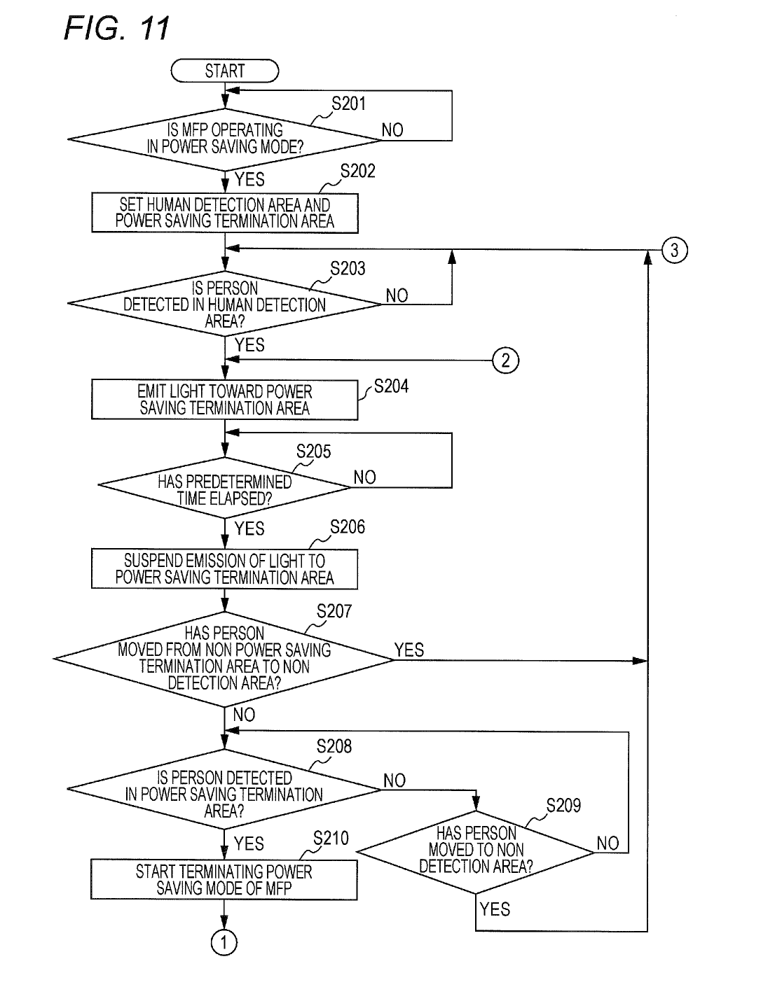

FIG. 11 is a flowchart for explaining an outline of a power supply control method according to examples of the second embodiment of the present invention. The control unit 190 executes the power supply control program Q stored in the HDD 192 to perform processes in the flowchart illustrated in FIG. 11.

In FIG. 11, since steps S201 to S204 are the same processes as those in steps S101 to S104 of examples of the first embodiment, detailed description thereof will not be repeated.

In step S205, the MFP 100 waits until a predetermined time elapses. The predetermined time may be a time period having a length sufficient for a person P who moved to the non power saving termination area to recognize the range of the power saving termination area D2 or a longer length.

Subsequently, light emission to the power saving termination area D2 is suspended (step S206). The control unit 190 controls the light emitting unit 170 to suspend light emission to the power saving termination area D2 so as not to illuminate the floor surface F in the power saving termination area D2 with light.

Subsequently, it is determined whether or not a person has moved from the non power saving termination area to the non detection area (step S207). If a person has moved from the non power saving termination area to the non detection area (step S207: YES), the method proceeds to the process in step S203.

If a person has not moved from the non power saving termination area to the non detection area (step S207: NO), it is determined whether or not a person is detected in the power saving termination area D2 (step S208). If no person is detected in the power saving termination area D2 (step S208: NO), it is determined whether or not a person has moved to the non detection area (step S209). If a person has moved to the non detection area (step S209: YES), the method proceeds to the process in step S203. If a person has not moved to the non detection area (step S209: NO), the method proceeds to the process in step S208.

If a person is detected in the power saving termination area D2 (step S208: YES), termination of the power saving mode of the MFP 100 is started (step S210).

Since subsequent processes are the same as those in steps S112 to S118 of examples of the first embodiment illustrated in FIG. 5B, detailed description thereof will not be repeated.

### Sixth Example

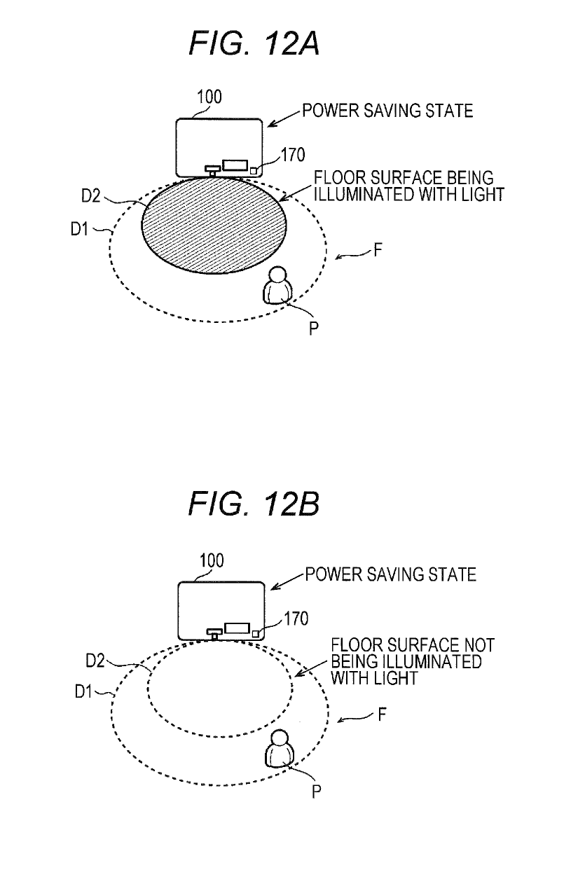

FIGS. 12A and 12B are schematic views for explaining a sixth example of the power supply control method according to examples of the second embodiment of the present invention.

As illustrated in FIG. 12A, since a person P has moved to the non power saving termination area, the floor surface F in the power saving termination area D2 is illuminated with light (step S204). In addition, since no person is present in the power saving termination area D2, the MFP 100 is in the power saving state.

Subsequently, as illustrated in FIG. 12B, the person P is still in the non power saving termination area after elapse of a predetermined time. Since the predetermined time has elapsed, the control unit 190 controls the light emitting unit 170 to suspend emission of laser light to the power saving termination area D2. Note that the predetermined time can be set by the user with use of the operation panel 140.

The image forming apparatus, the power supply control method, and the power supply control program according to examples of the present embodiment described above produces the following advantageous effect in addition to the effects of examples of the first embodiment.

As a result of suspending emission of laser light to the power saving termination area D2 after elapse of the predetermined time since a person P moved to the non power saving termination area, power consumption due to laser light emission can be reduced.

### Third Embodiment

In examples of the third embodiment, a case in which at least one of a plurality of people present in the non power saving termination area has moved to the power saving termination area will be described. Since configurations in examples of the present embodiment corresponding to those illustrated in FIGS. 1, 2, and 4 of examples of the first embodiment are the same as those in FIGS. 1, 2, and 4, the description thereof will not be repeated. Furthermore, in the following description, detailed description of part that overlaps with examples of the first embodiment will not be repeated.

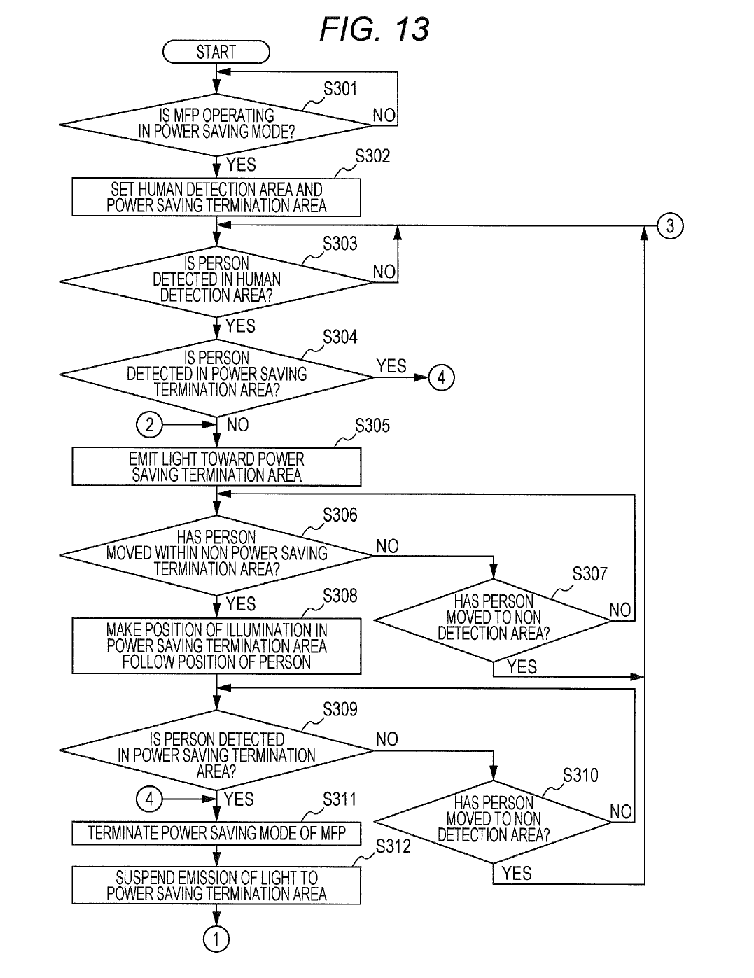

FIG. 13 is a flowchart for explaining an outline of a power supply control method according to examples of the third embodiment of the present invention. The control unit 190 executes the power supply control program Q stored in the HDD 192 to perform processes in the flowchart illustrated in FIG. 13.

In FIG. 13, since steps S301 to S303 are the same processes as those in steps S101 to S103 of examples of the first embodiment, detailed description thereof will not be repeated.

In step S304, it is determined whether or not a person is detected in the power saving termination area D2. If no person is detected in the power saving termination area D2 (step S304: NO), light is emitted toward the power saving termination area D2 (step S305). If a person is detected in the power saving termination area D2 (step S304: YES), the power saving mode of the MFP 100 is terminated (step S311). Since the processes in step S305 and subsequent steps are the same as those in step S104 and subsequent steps in the first embodiment, detailed description thereof will not be repeated.

### Seventh Example

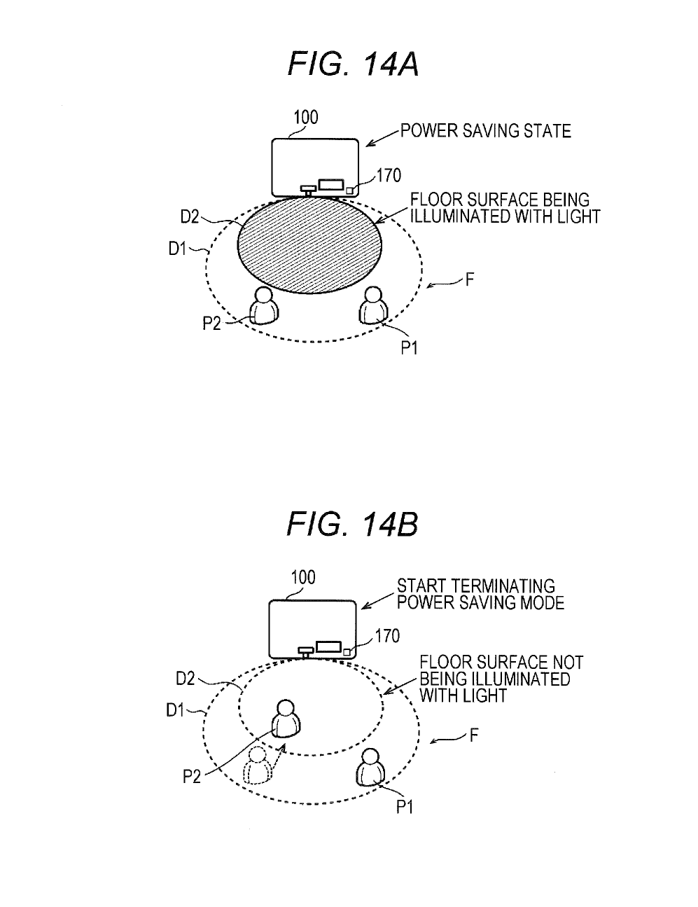

FIGS. 14A and 14B are schematic views for explaining a seventh example of the power supply control method according to examples of the third embodiment of the present invention.

As illustrated in FIG. 14A, since no person is present in the power saving termination area D2 while a person P1 and a person P2 are present in the non power saving termination area, the MFP 100 is in the power saving state and the floor surface F in the power saving termination area D2 is illuminated with light.

Subsequently, as illustrated in FIG. 14B, when one of the person P1 and the person P2, for example the person P2, has moved from the non power saving termination area to the power saving termination area D2, termination of the power saving mode is started and light emission to the floor surface F in the power saving termination area D2 is suspended.

In this manner, even when the person P1 is present in the non power saving termination area, the power saving mode is terminated when the person P2 has moved to the power saving termination area D2. Furthermore, when three or more people are present in the non power saving termination area, the power saving mode is also terminated when at least one of the people has moved to the power saving termination area D2.

The image forming apparatus, the power supply control method, and the power supply control program according to examples of the present embodiment described above produces the following advantageous effects in addition to the effects of examples of the first and second embodiments.

Even when a person is present in the non power saving termination area and a person is present in the power saving termination area D2, the control unit 190 can start termination of the power saving mode of the MFP 100.

Furthermore, even when multiple people are present in the non power saving termination area, since the area in which the power saving mode is terminated is illuminated with light in the surrounding area of the MFP 100, it is possible to notify people around the MFP 100 of the area in which the power saving mode is terminated.

### Fourth Embodiment

In examples of the first to third embodiments, description has been made on cases in which the imager of the human detecting unit is kept always-on after being turned on. In contrast, in examples of the fourth embodiment, description will be made on a case in which, when a person has moved to the power saving termination area, termination of the power saving mode of the MFP is started, light emission toward the power saving termination area is suspended, and the imager of the human detecting unit is turned off. Since configurations in examples of the present embodiment corresponding to those illustrated in FIGS. 1, 2, and 4 of examples of the first embodiment are the same as those in FIGS. 1, 2, and 4, the description thereof will not be repeated. Furthermore, in the following description, detailed description of part that overlaps with examples of the first embodiment will not be repeated.

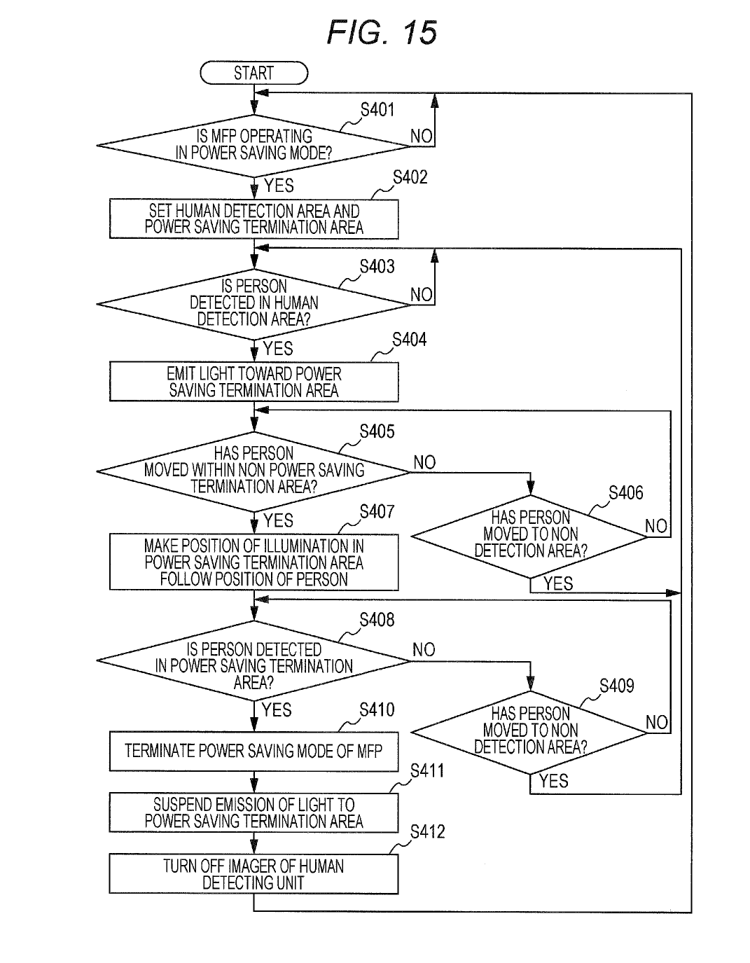

FIG. 15 is a flowchart for explaining an outline of a power supply control method according to examples of the fourth embodiment of the present invention. The control unit 190 executes the power supply control program Q stored in the HDD 192 to perform processes in the flowchart illustrated in FIG. 15.

In FIG. 15, since steps S401 to S411 are the same processes as those in steps S101 to S111 of examples of the first embodiment, detailed description thereof will not be repeated.

In step S412, the imager of the human detecting unit 160 is turned off. In examples of the present embodiment, taking pictures of the human detection area D1 with the imager of the human detecting unit 160 is suspended. The method then proceeds to the process in step S401.

### Eighth Example

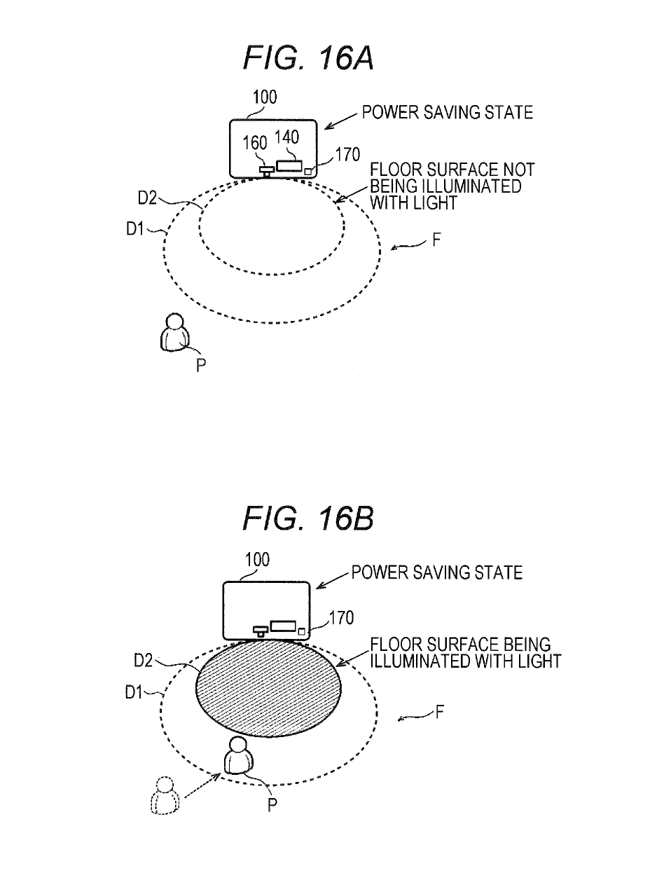

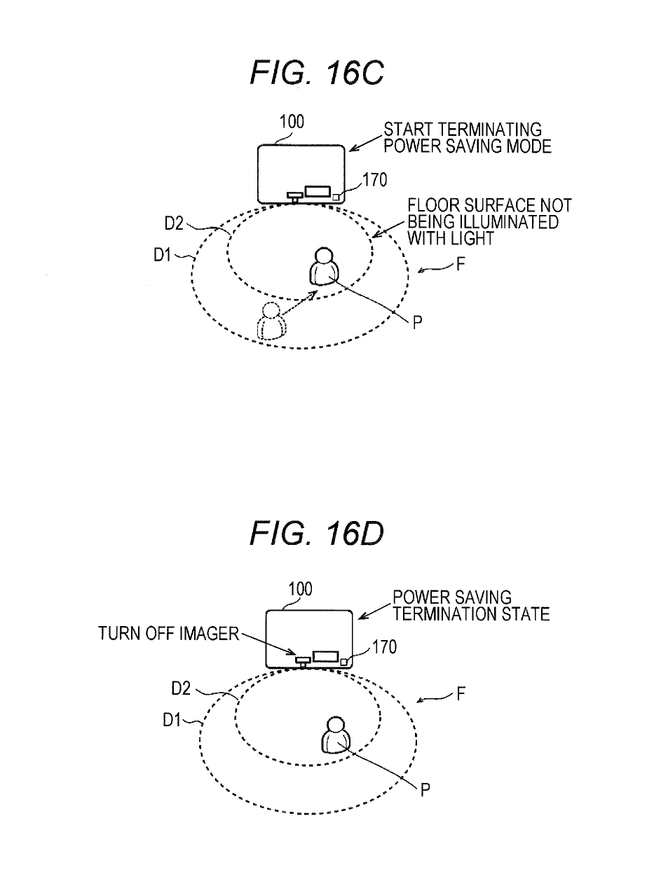

FIGS. 16A to 16D are schematic views for explaining an eighth example of the power supply control method according to examples of the fourth embodiment of the present invention.

As illustrated in FIGS. 16A to 16C, the processes through which a person P who was initially present in the non detection area reaches the power saving termination area D2 via the non power saving termination area are the same as those in the first example (FIGS. 6A to 6C).

As illustrated in FIG. 16D, since the person P is present in the power saving termination area D2, the MFP 100 is in the power saving termination state. The control unit 190 performs control to turn off the imager of the human detecting unit 160 (S412).

As described above, in the power supply control method illustrated in FIG. 15, when a person P has moved to the power saving termination area D2, termination of the power saving mode of the MFP 100 is started, illumination of the power saving termination area D2 with light is suspended, and the imager of the human detecting unit 160 is turned off.

The image forming apparatus, the power supply control method, and the power supply control program according to examples of the present embodiment described above produces the following advantageous effect in addition to the effects of examples of the first to third embodiments.

Since the imager of the human detecting unit 160 is turned off when the MFP 100 is in the power saving termination state, the power consumption of the human detecting unit 160 can be reduced.

### Fifth Embodiment

In examples of the third embodiment, the case in which at least one of a plurality of people present in the non power saving termination area has moved to the power saving termination area while the imager of the human detecting unit is always on has been described. In contrast, in examples of the fifth embodiment, a case in which the imager of the human detecting unit is turned off in a state in which people are present in the non power saving termination area and the power saving termination area will be descried. Since configurations in examples of the present embodiment corresponding to those illustrated in FIGS. 1, 2, and 4 of examples of the first embodiment are the same as those in FIGS. 1, 2, and 4, the description thereof will not be repeated. Furthermore, in the following description, detailed description of part that overlaps with examples of the third embodiment will not be repeated.

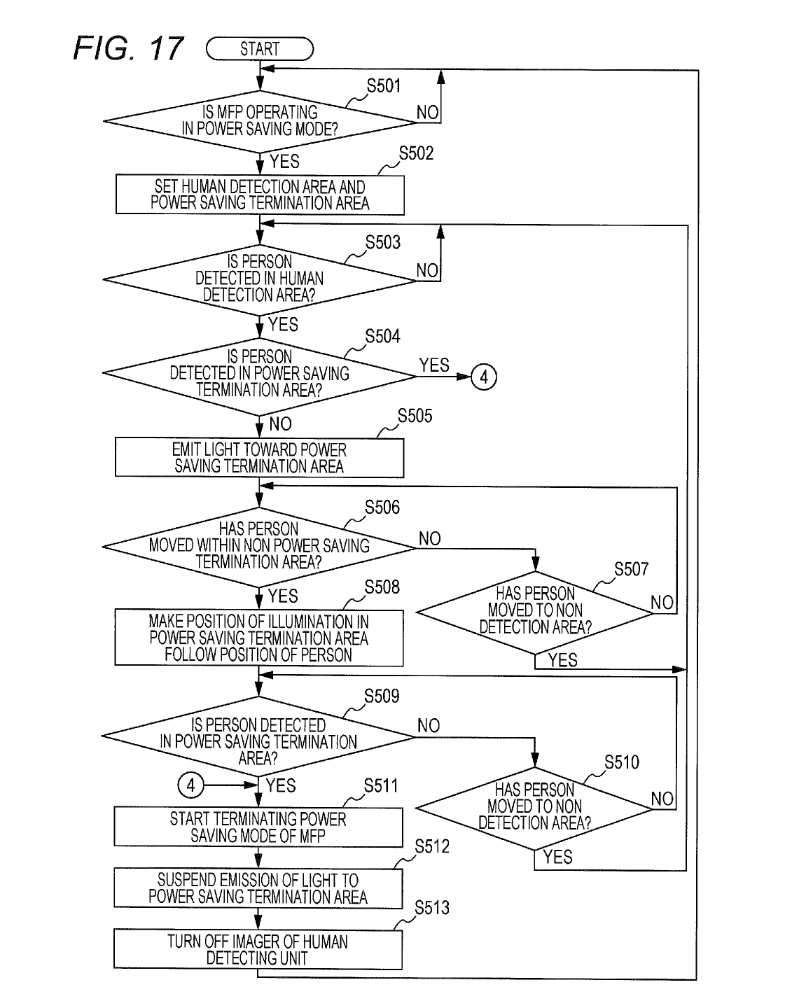

FIG. 17 is a flowchart for explaining an outline of a power supply control method according to examples of the fifth embodiment of the present invention. The control unit 190 executes the power supply control program Q stored in the HDD 192 to perform processes in the flowchart illustrated in FIG. 17.

In FIG. 17, since steps S501 to S512 are the same processes as those in steps S301 to S312 of examples of the third embodiment, detailed description thereof will not be repeated.

In step S513, the imager of the human detecting unit 160 is turned off. In examples of the present embodiment, taking pictures of the human detection area D1 with the imager of the human detecting unit 160 is suspended. The method then proceeds to the process in step S501.

### Ninth Example

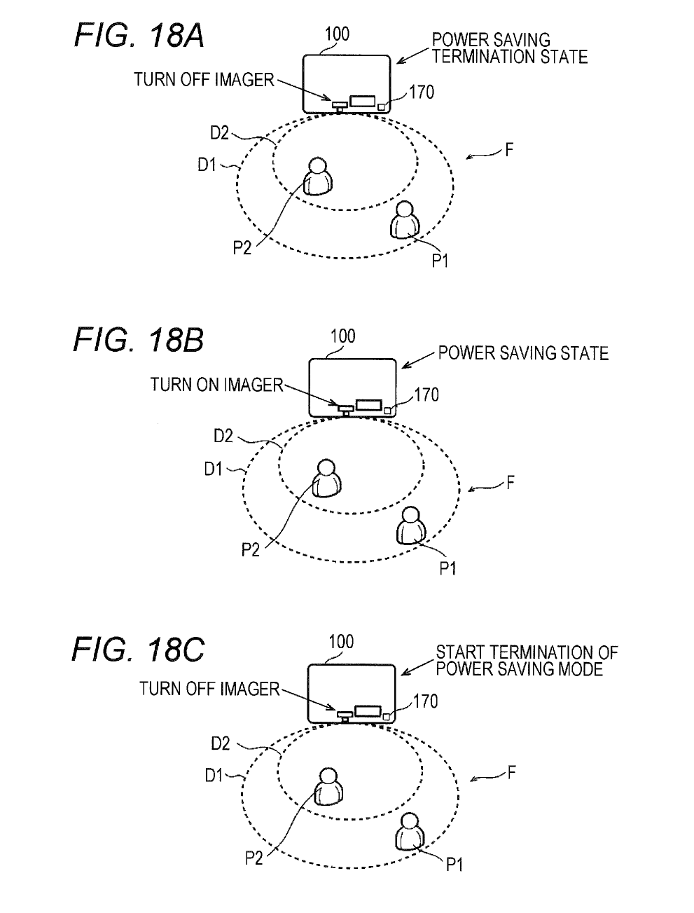

FIGS. 18A to 18C are schematic views for explaining a ninth example of the power supply control method according to examples of the fifth embodiment of the present invention.

As illustrated in FIG. 18A, a person P1 is present in the non power saving termination area and a person P2 is present in the power saving termination area D2. Since the person P2 is present in the power saving termination area D2, the MFP 100 is in the power saving termination state and the imager of the human detecting unit 160 is turned off.

Subsequently, as illustrated in FIG. 18B, when MFP 100 becomes in the power saving state, the control unit 190 sets the human detection area D1 and the power saving termination area D2 (step S502). The control unit 190 turns on the imager of the human detecting unit 160 and sets the human detection area D1 and the power saving termination area D2.

Subsequently, as illustrated in FIG. 18C, the human detecting unit 160 detects a person P1 and a person P2 in the human detection area D1 (step S503), and further detects the person P2 in the power saving termination area D2 (step S504: YES). Thus, the control unit 190 starts terminating the power saving mode of the MFP 100 (step S511). Subsequently, the control unit 190 turns off the imager of the human detecting unit 160 (step S513), and the method proceeds to the process in step S501.

In this manner, In the power supply control method illustrated in FIG. 17, the imager of the human detecting unit 160 is turned off in a state in which people are present in the non power saving termination area and in the power saving termination area D2. Thereafter, when the MFP 100 enters the power saving state and the human detecting unit 160 detects a person in the power saving termination area D2, the control unit 190 starts terminating the power saving mode of the MFP 100.

The image forming apparatus, the power supply control method, and the power supply control program according to examples of the present embodiment described above produces the following advantageous effect in addition to the effects of examples of the first to fourth embodiments.

Even when a person is present in the non power saving termination area and a person is present in the power saving termination area D2, the control unit 190 starts terminating the power saving mode of the MFP 100 and turns off the imager of the human detecting unit 160, which can reduce the power consumption of the human detecting unit 160.

As described above, certain embodiments of the image forming apparatus, the power supply control method, and the power supply control program according to the present invention have been descried. Needless to say, however, further addition, modification, and omission can be made as necessary by those skilled in the art within the scope of the technical idea of the present invention.

For example, in examples of the first to fifth embodiments, the cases in which the human detecting unit mounted in the front of the housing of the image forming apparatus is used to detect mainly a person in front of the image forming apparatus have been described. The present invention, however, is not limited to such cases. For example, the human detecting unit may be mounted separately from the body of the image forming apparatus at a position and orientation in which the human detecting unit can detect the state of the whole image forming apparatus body, so as to set the human detection area and the power saving termination area around the image forming apparatus body. As a result of setting the human detection area and the power saving termination area in this manner, a person at a side and a person at a back of the image forming apparatus can also be detected in addition to a person in front of the image forming apparatus.

Furthermore, in examples of the first to fifth embodiments, description has been made on the cases in which the light emitting unit includes a projector with a light source being a laser pointer or a laser, and laser light is emitted toward the power saving termination area so that the power saving termination area is illuminated with light. The present invention, however, is not limited to the cases in which laser light is emitted toward the power saving termination area, but a light emitting element or the like may be disposed under the floor surface to make the floor surface in the power saving termination area luminous, so that the power saving termination area is illuminated with light.

Furthermore, in examples of the first to fifth embodiments, description has been made on the cases in which the control unit of the image forming apparatus has a power supply control program, and the control unit controls the human detecting unit and the light emitting unit. The power supply control program, however, is not limited to be provided in the control unit of the image forming apparatus. For example, the power supply control program may be provided in a server connected to the image forming apparatus via a network, and a CPU of the server may be configured to control the human detecting unit and the light emitting unit by executing the power supply control program.

Furthermore, in examples of the first to fifth embodiments, description has been made on the cases in which a CPU of the control unit that performs control (job execution control, etc.) in the normal mode performs control in the power saving mode. A control unit (sub CPU) configured to perform control in the power saving mode, however, may be provided in addition to a control unit (main CPU) that performs control in the normal mode.

Furthermore, to prevent termination of the power saving mode when a person unintentionally enters the power saving termination area, the control unit may be configured such that the human detecting unit takes the time during which the person stays in the power saving termination area into account in detecting a person in the power saving termination area. In other words, the control unit may be configured to recognize only a person detected in the power saving termination area and staying in the power saving termination area for a predetermined threshold or longer as a detected person.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image forming apparatus comprising:
an image former, accommodated in a housing, that forms an image on a sheet;
a human detector that detects a person;
a light emitter that emits light;
a power supplier that supplies power to the image former in any of multiple power supply modes,
wherein the multiple power supply modes comprises a normal mode in which power enabling image forming by the image former is supplied and a power saving mode in which less power is supplied than in the normal mode; and
a controller that:
sets a first detection area positioned outside of the housing and a second detection area contained in the first detection area;
controls the light emitter to emit the light when the human detector detects the person in the first detection area; and
controls the power supply to start terminating the power saving mode when the human detector detects the person in the second detection area.

2. The image forming apparatus according to claim 1, wherein
the controller controls the light emitter to illuminate the second detection area with light when the human detector detects the person in a third detection area that is an area excluding the second detection area from the first detection area.

3. The image forming apparatus according to claim 1, wherein
the light emitter emits light toward a floor surface in the second detection area.

4. The image forming apparatus according to claim 3, wherein
the human detector comprises a sensor that locates a position of the person, and
the controller controls the light emitter to change a position of light emission on the floor surface in the second detection area according to the position of the person.

5. The image forming apparatus according to claim 4, wherein
the controller controls the light emitter to draw a marker following movement of the person in the third detection area and indicating a direction to the housing from the person.

6. The image forming apparatus according to claim 1, wherein
when the human detector detects the person in the second detection area, the controller controls the power supply to start terminating the power saving mode and turn off a sensor of the human detector.

7. The image forming apparatus according to claim 2, wherein
when the human detector detects the person in the third detection area, the controller determines whether the person has moved from outside of the first detection area to the third detection area or from the second detection area to the third detection area,
when the controller determines that the person has moved from outside of the first detection area to the third detection area, the controller controls the light emitter to illuminate the second detection area with light, and
when the controller determines that the person has moved from the second detection area to the third detection area, the controller controls the light emitter not to illuminate the second detection area.

8. The image forming apparatus according to claim 2, wherein
when the controller determines that the person has stayed in the third detection area longer than a predetermined time, the controller controls the light emitter to suspend illumination of the second detection area with light.

9. The image forming apparatus according to claim 2, wherein
when the controller determines that the person has moved from the third detection area to the second detection area and the human detector detects the person in the second detection area and another person in the third detection area at the same time, the controller controls the light emitter to suspend illumination of the second detection area with light and controls the power supply to start terminating the power saving mode.

10. The image forming apparatus according to claim 6, wherein
when the human detector detects the person in the second detection area and another person in the third detection area at the same time, the controller controls the power supply to start terminating the power saving mode.

11. The image forming apparatus according to claim 2, wherein
when the controller determines that the person has moved from the second detection area to the third detection area and that another person has moved from outside of the first detection area to the third detection area, the controller controls the light emitter to illuminate the second detection area with light.

12. A power supply control method comprising:
setting a first detection area positioned outside of a housing of an image forming apparatus and a second detection area contained in the first detection area and located adjacent to the housing;
controlling a light emitter to emit light when a person is detected in the first detection area; and
controlling a power supply to start terminating a power saving mode when the person is detected in the second detection area.

13. The power supply control method according to claim 12, wherein
the controlling the light emitter to illuminate with light further comprises controlling the light emitter to illuminate the second detection area with light when the person is detected in a third detection area that is an area excluding the second detection area from the first detection area.

14. The power supply control method according to claim 12, wherein
the controlling the light emitter to illuminate with light further comprises controlling the light emitter to emit light toward a floor surface in the second detection area.

15. The power supply control method according to claim 13, wherein
the controlling the light emitter to illuminate the second detection area with light further comprises controlling the light emitter to draw a marker indicating a direction to the housing from a position of the person in the second direction area, the marker following movement of the person.

16. The power supply control method according to claim 13, further comprises:
determining whether the person has moved from outside of the first detection area to the third detection area or from the second detection area to the third detection area when the person is detected in the third detection area;
controlling the light emitter to illuminate the second detection area with light when it is determined that the person has moved from outside of the first detection area to the third detection area; and
controlling the light emitter not to illuminate the second detection area when it is determined that the person has moved from the second detection area to the third detection area.

17. The power supply control method according to claim 13, wherein
the controlling the power supply to start terminating the power saving mode further comprises controlling the power supply to start termination of the power saving mode when the person is detected in the second detection area and another person is detected in the third detection area at the same time.

18. The power supply control method according to claim 13, wherein
the controlling the light emitter to illuminate the second detection area with light further comprises controlling the light emitter to illuminate the second detection area with light when it is determined that the person has moved from the second detection area to the third detection area and another person has moved from outside of the first detection area to the third detection area.

19. A non-transitory recording medium storing a computer readable power supply control program causing a computer to execute the power supply control method according to claim 12.
